(19) United States
(12) Patent Application Publication
(10) Pub. No.: US 2003/0128219 A1
(43) Pub. Date: Jul. 10, 2003

(54) Pixel color map operator interface

(75) Inventors: Robert J. Manard, Rochester, NY (US); Shiang-Yee Lee, Rochester, NY (US)

Correspondence Address: Mark S. Svat, Fay, Sharpe, Fagan, Minnich & McKee, LLP, 7th Floor, 1100 Superior Avenue, Cleveland, OH, 44114-2518, US

(73) Assignee: XEROX CORPORATION

(21) Appl. No.: 10/040,989

(22) Filed: Jan. 7, 2002

(51) Int. Cl. G09G 5/02

(52) U.S. Cl. 345/589

(57) ABSTRACT

The present invention provides for a pixel color map operator interface, incorporated into a computer system. Images are displayed on the screen monitor of a computer system, and in one embodiment the images represent machine components. The operator interacts with the computer system by selection of a desired image via a pointing device, which activates sensitive regions of the image based on the pixel color value. Upon selection and activation of the sensitive region, which is mapped to a program algorithm, an operator desired function, programmed into the application, is performed by the computer system. The pixel color map operator interface eliminates the need for geographic mapping of a single bitmap or the conglomeration of several bitmaps by basing selection and activation on the color value of a selected pixel.

### BACKGROUND OF THE INVENTION

The present invention relates to the art of operator interaction with a computer system via images on a display screen monitor of a computer. It finds particular application in conjunction with graphical user interfaces (GUIs), computer graphics for animation, selection, control of printers and web-based presentations, and will be described with particular reference thereto. However, it is to be appreciated that the present invention is also amenable to other applications as well.

Ordinarily, computer programs which implement GUIs interact with polygonal shapes using image maps in HTML. One way in which this is accomplished is to use coordinate specified polygons to determine the selection area. This solution is commonly found in HTML-based image maps. Another solution is to use a combination of several bitmaps and sensitive regions, where each sensitive region would have its own bitmap.

Thus, present graphical user interfaces provide interaction with the computational system by defining interactive regions on the display devices, such as a screen, which correspond to point and click commands from a user to perform a desired function. The regions are mapped geographic regions with a coordinate system and height and width dimensions for polygons to determine the selection area. This solution is commonly found in HTML based image maps or files.

Files such as GIF files, or JPEG files can also be used in determining a sensitive region within a coordinate system and where the sensitive region has its own bitmap. A GIF file, for example, would have corresponding button locations on the display. The computer program checks the appropriate region of where the mouse pointer was clicked or activated. The interface program executes programming code which is sent to a software application and determines the coordinates, height and width dimensions of the region and then performs the appropriate program to obtain the function desired by the user.

While encoding a plain polygon shape, such as a rectangle, is fairly straight forward, a drawback of these above mentioned processes is that it makes encoding difficult for irregular shaped objects such as a depiction of a machine component. Due to this, designs associated with existing GUIs are not as varied as they might be if such systems did not require these mapped geographic regions.

### SUMMARY OF THE INVENTION

In accordance with one aspect of the present invention is a computer system application program which performs operator interactive functions or commands. The computer system has an input, such as a mouse or a trackball, through which an operator interacts with the application program. The computer system includes an output interface through which desired commands from the application program are implemented to perform the desired functions. The operator interface application includes a pixel color map with sensitive regions which are color dependent. The operator interface application is programmed to acquire samples of the pointing device signal and process that signal to perform commands based on pixel color values.

In accordance with another aspect of the present invention, there is provided a system which keys a graphical display interface to actions on pixel color values of a displayed image, rather than object shapes. When pixel color values at a mouse coordinate equal a designated color, actions such as changing cursor positions and allowing hyperlinks to be followed are performed by the browser. The invention is reduced to practice using Java applets with JPEG and GIF bitmaps, however it is to be appreciated that other programming languages will yield the same results.

In accordance with another aspect of the present invention, there is provided a system which is generally applicable to a distributed computational environment and can be extended to animation.

The present invention overcomes the inherent gross inefficiencies of the prior art methods and systems for displaying and performing operations on graphical interactive interfaces. Irregular shapes depicting machine parts makes HTML encoding difficult, with the pixel color map, the encoding is reduced and simplified, as opposed to the prior art.

### BRIEF DESCRIPTION OF THE DRAWINGS

The present invention exists in the construction, arrangement, and combination of the various parts of the system, and steps of the method, whereby the aspects, objects and/or advantages contemplated are attained as hereinafter more fully set forth, specifically pointed out in the claims, and illustrated in the accompanying drawings in which:

FIG. 1 is an illustration of a checkered image in which there are two possible actions, two different colored regions, when using a pixel color map.

FIG. 2 is an illustration of a checkered image in which there are six possible actions, six different colored regions, when using a pixel color map.

FIG. 3 is an illustration of a swirled image which is not more complex to map, than the checkered image with six different regions, when mapped using a pixel color map.

FIG. 4 is an illustration of various complex images which are not more complex to map, than the checkered image with six different regions, when mapped using the present pixel color map invention.

FIG. 5 is a flow chart diagram representing a method for the pixel color map operator interface.

FIG. 6 is a flow chart diagram representing an alternative method for the pixel color map operator interface through the use of an offscreen action bitmap.

### DETAILED DESCRIPTION OF THE INVENTION

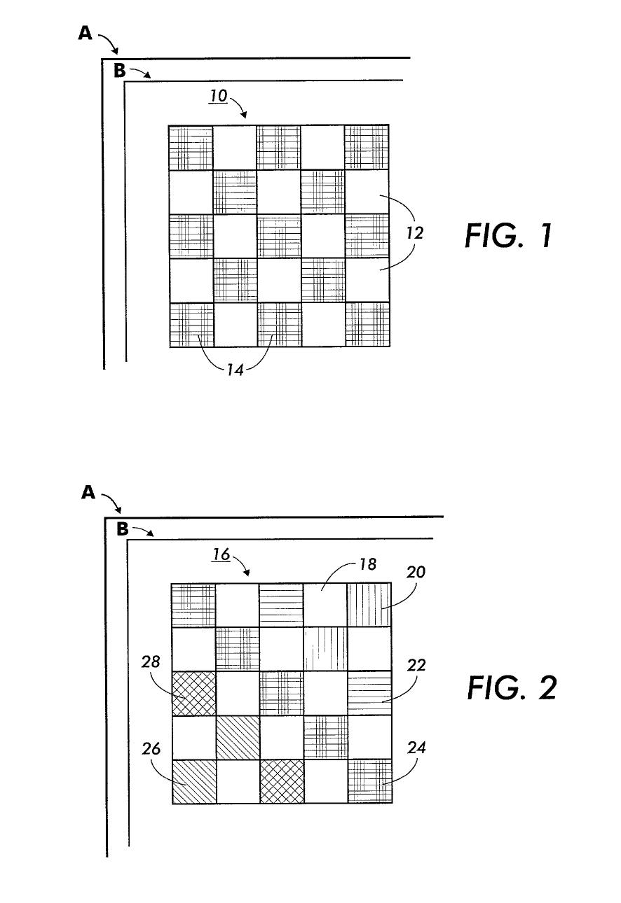

Referring now to the drawings wherein the showings are for purposes of illustrating the preferred embodiments of the invention only and not for the purposes of limiting the same. FIG. 1 depicts a computer system A, including a monitor screen B on which is located a pixel color map having a checkered image 10, representative of one type of pixel color map according to concepts of the present invention. It is to be understood that computer systems A is intended to include all types of electronic computational devices which would benefit or use graphical user interfaces.

In a first embodiment the color values of the white 12 and black 14 squares are mapped to an identical offscreen action bitmap, to a look-up table or other offscreen design which associates the color values with a program algorithm designed to perform an operator desired function by the computer system. The pixel color map operator interface eliminates the need for geographic mapping of a single bitmap or the conglomeration of several bitmaps. By basing selection and activation on the color value of a selected pixel, it becomes easier to specify and perform actions for selection of specific areas of an image. The display image pixel color values are used directly as the action map or an offscreen bitmap can be used as the action map for a displayed one. In any event, it is the selected pixel color value which determines the function performed by the computer system running the application program.

Thus, the pixel color map operator interface allows for a complex segregation and aggregation of selection area of an image. The pixel color map operator interface which uses checkered image 10 is in one embodiment configured to perform two actions, for the two different colored regions, white 12 and black 14. Using existing technology would have required the specification of twenty-five different regions (for two possible actions). It is to be appreciated, that for this particular example while white and black are used, different colors and shades of colors may also be used. Because selection is based on pixel color values, selecting any one of the white 12 squares results in a same first function for any white square selection. Likewise, selection of any one of the black 14 squares results in the same second function being performed.

With reference to FIG. 2, illustrated is a multicolored checkered image 16 having six different colored regions, here depicted as five different shaded regions and the white squares or regions. Traditionally, this would have required the specification of twenty-five different areas (for six possible actions). Using the pixel color map operator interface, requires only the six different colored regions. Alternatively, this could be used as the offscreen action map for the displayed black and white image (or vice versa). In this way, it could still be possible to use the pixel color map improvements, allowed by this invention, with the flexibility to use any image to be displayed.

Again with reference to FIG. 2, in an exemplary embodiment, and without intending to limit the present invention, the white color 18 of the image, when selected, results in the function of checking toner level in a printer. Selection of the red color 20 results in the function of checking paper status. Selection of the blue color 22 results in the function of checking the number of copies printed. Selection of the black color 24 results in the function of running diagnostics on the master control board. Selection of the green color 26 results in the function of running diagnostics on the communications board. Selection of the yellow color 28 results in the function of running diagnostics.

With continuing attention to FIG. 2, in an alternative embodiment, the pixel color map interface may map different color values to the same function. For example, whereas selection of red color resulted in a function of checking the paper status, and selection of the blue color resulted in the function of checking the number of copies printed, the mapping of the colors in the system may be such that selection of both red and blue will cause the function of checking the paper status. This concept permits a greater flexibility in the use of color allowing any image and multiple colors desired for display.

As will be discussed in greater detail below, the mapping of the displayed pixel color map may be accomplished directly, i.e., the value of the color pixel will be mapped a lookup table having a correspondingly matched instruction. Alternatively, and as will be described in connection with FIGS. 1 and 2 together, the display map may be mapped to a non-identical offscreen action map. For example, in this discussion, the multicolored pixel color map of FIG. 2 will be the map shown on the screen monitor B. The two-colored checkerboard map of FIG. 1 will be the offscreen action map stored at some location in the memory of the computer. Then, and when the user wishes to map two or more colors to the same action, this may be accomplished using the offscreen action map. Particularly, if in FIG. 2 only two actions are to be undertaken, then three of the colors (e.g., 18, 20, 22) could be mapped to the white colored box of the offscreen map (12) and the remaining three colors (24, 26, 28) to the black colors of the offscreen map (14). It is to be appreciated that this change is done only as an example and other arrangements could be used to accomplish this outcome. For example, if a look-up table were used, multiple colors may be associated with the same instruction.

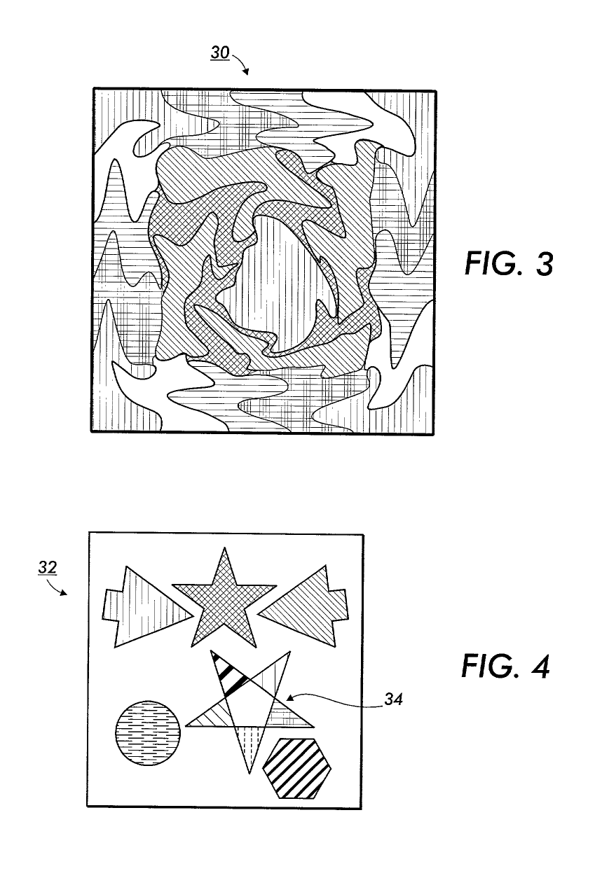

With reference to FIG. 3, illustrated is a multicolored swirled image 30, depicted as a multiple grey scale swirled image. This image would be very difficult to map with the existing technology. However, by using the pixel color map, it is no more complex than the multicolored checkered image.

With reference to FIG. 4, illustrated are various complex images 32 each having different shapes and colors, depicted as different shaded regions. These complex shapes are not more complex to map, than the checkered image with six different regions, when mapped using a pixel color map. Traditionally, these images would be very difficult to map with the existing technology. For example, it is to appreciated that when using the prior art technology it quickly becomes cumbersome to map an object such as star 34, requiring mapped coordinates, colors, and height and width dimensions, to properly identify this object. Other alternative represented images include but not limited thereto, are status indicators, such as toner levels, job complete status etc., which allow the operator to interact with complex and sophisticated technologies through the intuitive nature of the images. An operator interacts with the computer system by selection of a desired image via a pointing device, which activates sensitive regions of the image based on pixel color values.

Because the pixel color map operator interface does not require height and width dimensions the invention requires less code and is faster than traditional approaches. Moreover, it has the potential for more efficient operation when applied to web based presentations as well as local GUIs.

The present invention has been reduced to practice by creating a prototype in Java, using JPEG and GIF bitmaps. Such an approach permits the use of anonymous image data and generates execution speeds which are faster than existing systems. The approach of this embodiment also allows the operator to use interactive graphics and sensitive region data to support application specific interactions. Additionally, this keeps the displayed image isolated from the application and preserves the cross-platform capabilities of the pixel color map application.

Concepts of the present invention correlates pointing device keying actions, performed by the operator, to pixel color values displayed on the monitor, rather than to displayed object shapes. In a network application, an image is displayed over the web. When certain pixel color values are detected by the action of the pointing device, actions such as changing cursor positions and allowing hyperlinks to be followed are performed by a browser in a networked application, for example. The present invention, in one embodiment, is reduced to practice using Java applets with JPEG and GIF bitmaps, however it is to be appreciated that other programming languages will yield similar results. Moreover, the pixel color map operator interface is also applicable in a distributed computational environment and can be extended to animation.

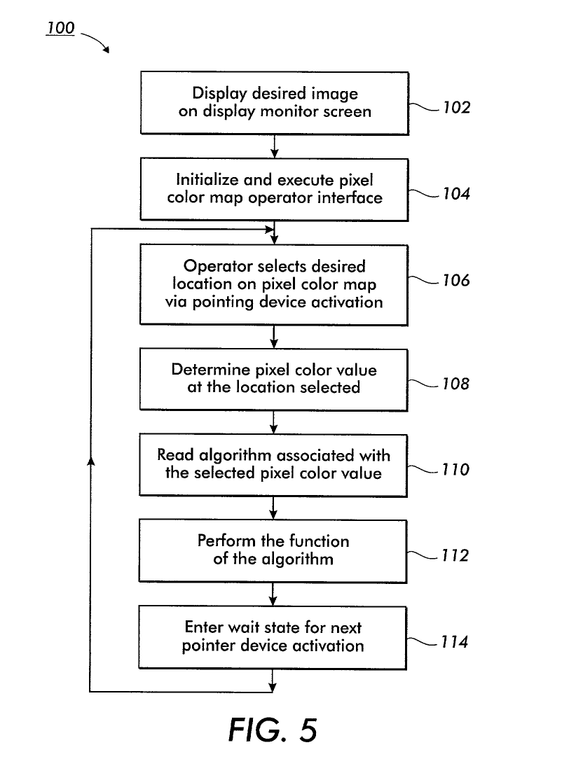

With reference to FIG. 5, illustrated is a flow chart diagram an embodiment of the pixel color map operator interface 100. As shown, the method starts with a desired image or icon displayed on the computer monitor screen (step 102). The pixel color map operator interface program is initialized and executed on the computer system (step 104). The operator interfaces with the computer system by selecting a particular location on the pixel color bit map, using a pointing device (step 106). The application will then determine the pixel color value at the selected location (step 108). Next, an algorithm associated with the selected pixel color value is read from a storage media (step 110). The application will then perform the function of the algorithm, for example run a diagnostic (step 112). The application program will then enter a wait state for the next activation by the pointing device (step 114).

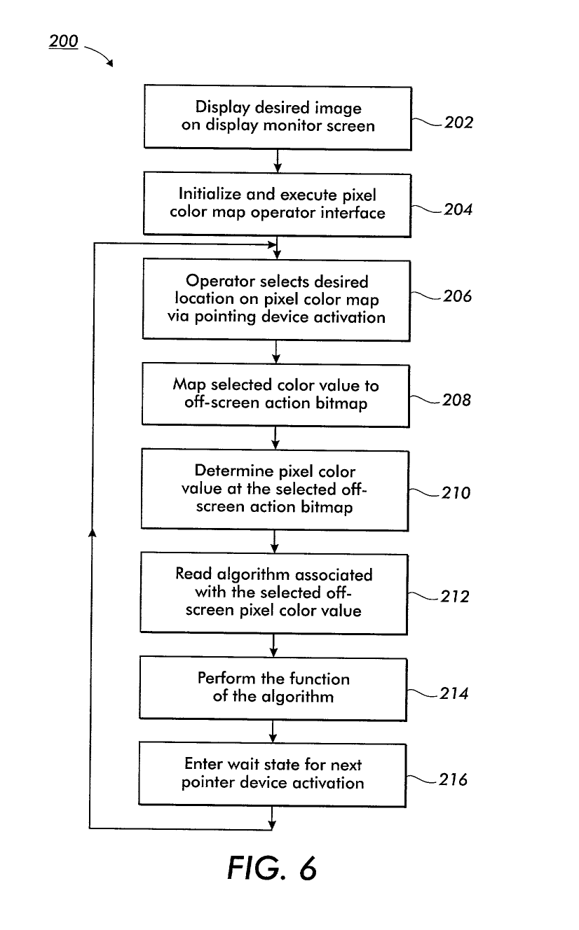

With reference to FIG. 6, illustrated is a flow chart diagram of a method 200 which implements the pixel color map operator interface with an offscreen bitmap. As shown, the method starts with a desired image displayed on the computer monitor screen (step 202). Next, the pixel color map operator interface program is initialized and executed on the computer system (step 204). The operator interfaces with the computer system by selecting a location on the bitmap, using a pointing device (step 206). Next, the selected color is mapped to an offscreen action bitmap (step 208). The application will then determine the pixel color value of the offscreen action bitmap at the selected activation region (step 210). Next, an algorithm mapped to the selected pixel color value is read from a storage media (step 212). The application will then perform the function of the algorithm, for example run a diagnostic, (step 214). The application program will then enter a wait state for the next activation by the pointing device (step 216) until an operator selects a desired region via a pointing device.

The invention has been described with reference to the preferred embodiment. Obviously, modifications and alterations will occur to those skilled in the art upon reading and understanding of this specification. The invention is intended to include all such modifications and alterations insofar as they come within the scope of the appended claims or equivalents thereof.

What is claimed is:

1. A computer system performing interactive commands, comprised of:
an input responsive to an operator action;
an output for performing a computer program function;
an operator graphical interface including a pixel color map supported on the computer system, displayed on a computer monitor display screen and being engaged by the operator via the input means to selectively activate a sensitive region on the display screen; and
a location designated therein the pixel color map which triggers the computer program function.

2. The computer system according to claim 1, wherein the operator graphical interface includes files selected from the group of a GIF file, a JPEG file, an HTML file, and an offscreen file.

3. The computer system according to claim 1, wherein the input means is a computer mouse, a trackball, or a keyboard.

4. The computer system according to claim 1, wherein the output means is a computer digital output.

5. The computer system according to claim 1, wherein the output means is a computer analog output.

6. The computer system according to claim 1, wherein the computer program function performs diagnostics.

7. The computer system according to claim 1, the pixel color map is an offscreen bitmap.

8. The computer system according to claim 1, wherein an algorithm is mapped to a specific pixel color value and performs a particular computer program function.

9. The computer system according to claim 8, wherein a plurality of algorithms are mapped to a plurality of pixel color values.

10. A method of managing interactive commands on a computer system, said method comprising:
displaying a pixel color map image;
executing a pixel color map operator interface program;
selecting a desired region on said pixel color map image via a pointing device by an operator; and
performing a computer program function based on a pixel color value of the selected desired region.

11. The method according to claim 10, wherein an algorithm is mapped to each specific pixel color value.

12. The method according to claim 11, further comprising a plurality of algorithms, each of said algorithms being mapped to a specific pixel color value.

13. The method according to claim 10, wherein said computer program function is an analog function.

14. The method according to claim 10, wherein said computer program function is a digital function.

15. The method according to claim 10, wherein the pixel color map is an offscreen bitmap.

16. The method according to claim 10, wherein said computer program function is a diagnostic program.

17. A method of interacting with a computer system via a displayed image, said method comprising:
displaying a pixel color map image;
executing a pixel color map operator interface program;
selecting a desired region on said pixel color map image via a pointing device by an operator;
determining at least a first pixel color value at the desired region;
mapping an algorithm to the at least first pixel color value;
reading the algorithm from a storage device; and
performing a computer program function based on said algorithm.

18. The method according to claim 17, wherein said algorithm performs system diagnostics.

19. The method according to claim 17, wherein said algorithm performs an analog function.

20. The method according to claim 17, wherein said algorithm performs a digital function.
